(19) United States
(12) Patent Application Publication
(10) Pub. No.: US 2014/0209509 A1
(43) Pub. Date: Jul. 31, 2014

(54) SYSTEM AND PROCESS FOR HYDROCRACKING AND HYDROGENATION

(71) Applicant: H R D CORPORATION, Sugar Land, TX (US)

(72) Inventors: Abbas Hassan, Sugar Land, TX (US); Aziz Hassan, Sugar Land, TX (US); Rayford G. Anthony, College Station, TX (US); Gregory G. Borsinger, Chatham, NJ (US)

(73) Assignee: H R D Corporation, Sugar Land, TX (US)

(21) Appl. No.: 13/790,693

(22) Filed: Mar. 8, 2013

Related U.S. Application Data
(60) Provisional application No. 61/756,890, filed on Jan. 25, 2013.

(51) Int. Cl. C10G 45/00; F17D 1/00

(52) U.S. Cl. CPC C10G 45/00; F17D 1/00
USPC 208/108; 208/143; 208/209; 208/264; 585/250; 422/129; 422/187; 585/800; 516/10; 137/1

(57) ABSTRACT

Herein disclosed is a method for hydrogenation comprising: supersaturating a hydrocarbonaceous liquid or slurry stream in a high shear device with a gas stream comprising hydrogen and optionally one or more C1-C6 hydrocarbons to form a supersaturated dispersion; and introducing the supersaturated dispersion into a reactor in the presence of a hydrogenation catalyst to generate a product stream. In some embodiments, the catalyst is present as a slurry or a fluidized or fixed bed of catalyst. In some embodiments, the hydrogenation catalyst is mixed with the hydrocarbonaceous liquid or slurry stream and the gas stream in the high shear device. In some embodiments, the method further comprises recycling at least a portion of an off gas from the reactor, recycling at least a portion of the product stream from the reactor, or both. Also disclosed herein is a system for hydrogenation.

### CROSS-REFERENCE TO RELATED APPLICATIONS

This application claims benefit of U.S. Provisional Application Ser. No. 61/756,890 filed on Jan. 25, 2013, entitled “System and Process for Hydrocracking and Hydrogenation,” incorporated herein by reference in its entirety for all purposes.

### STATEMENT REGARDING FEDERALLY SPONSORED RESEARCH OR DEVELOPMENT

Not Applicable.

### BACKGROUND OF THE INVENTION

1. Technical Field

The present invention generally relates to a system and method of hydrocracking or hydrogenation that provides for improved product distribution of hydrocarbon compounds. More particularly, the present invention relates to supersaturating a liquid or slurry hydrocarbon stream with a gas stream comprising hydrogen in a high shear device to improve or induce hydrocracking reactions to produce a greater quantity of and/or a more desirable liquid product than would otherwise be produced.

2. Background of the Invention

Hydrogen is used in several petroleum and petrochemical processes in order to reduce unsaturation, reduce aromatic components, and reduce molecular weight of hydrocarbon feedstock for the production of jet fuel, gasoline components and LPG. Hydrogenation is assisted by the presence of an elevated partial pressure of hydrogen. Petroleum refinery hydrogenation processes are well known and developed. Such processes upgrade mixtures of hydrocarbons to supply more valuable product streams. The products of this process are saturated hydrocarbons. Depending on reaction conditions (temperature, pressure, and catalyst activity) the cracking products range from ethane, LPG to heavier hydrocarbons comprising mostly isoparaffins. Hydrocracking is normally facilitated by a dual function catalyst that is capable of rearranging and breaking hydrocarbon chains, as well as adding hydrogen to aromatics and olefins to produce naphthenes and alkanes.

The severity of hydrogenation is increased by operating with increasingly acidic catalysts and possibly at higher temperatures and longer contact times than in hydrotreating. Increased hydrogen pressure controls deposits and catalyst fouling. Unlike thermal or catalytic cracking, hydrocracking decreases the molecular weight of aromatic compounds and fills a specific need for processing streams high in aromatic material, such as cycle stocks from catalytic or thermal cracking, coker products, or coal liquids. For example, catalytic cycle stock can be cracked to a naphtha fraction that is an excellent feed for catalytic reforming to make premium-octane gasoline or petrochemical aromatic material. Major products from hydrocracking are jet fuel, diesel, relatively high octane rating gasoline fractions and LPG. These products may have a very low content of sulfur and contaminants. Reduction of molecular weight can also be accomplished by thermal cracking either with or without catalyst. In the Fischer Tropsch (FT) process, a high molecular weight, waxy compound is produced that must be reduced in molecular weight in order to be used as a liquid petroleum fuel (e.g., diesel, gasoline, aviation fuel). The reduction of molecular weight in the FT process can be accomplished by means of hydrocracking or catalytic cracking.

Fuel oil is a fraction obtained via petroleum distillation, either as a distillate or residue. Distillate fuel oils are distilled from crude oil. Gas oil refers to the process of distillation. The oil is heated, becomes a gas and condenses as gas oil. Gas oil is thus differentiated from residual oil. The terms heavy fuel oil and residual fuel oil are what remains of the crude oil after gasoline and the distillate fuel oils are extracted through distillation. Hydrogenation is used extensively on distillate stocks. The hydrogenation process is applied to refinery stocks for premium-quality kerosene, diesel and jet fuels. The light products from hydrocracking may also be rich in isobutane, an important raw material for alkylation.

In recent times, as the worldwide supply of light, sweet crude oil for refinery feedstock has diminished, there has been a significant trend toward conversion of higher boiling compounds to lower boiling ones. Due to this trend to heavier crude oil and the need for processing synthetic crude oil, hydrogenation has grown increasingly important. As demand for distillate fuels increases, refiners may incorporate hydrocrackers to convert, for example, vacuum gas oil (VGO) to jet and diesel fuel. Catalysts have been developed that exhibit desirable distillate selectivity, high conversion activity and stability for heavier feedstocks.

The hydrogen used in processes such as hydrocracking, hydrodesulfurization and hydrotreating is often supplied by means of a unit that utilizes steam reforming. The steam reforming process is capital intensive and thermally inefficient. Certain embodiments of the present disclosure produce hydrogen insitu from sources such as methane with reduced capital costs and better thermal efficiencies.

Oil refineries are utilized for processing crude oil and refining it into more useful petroleum products, such as gasoline, diesel fuel, asphalt base, heating oil, kerosene, and liquefied petroleum gas. Oil refineries are typically large sprawling industrial complexes with extensive piping running throughout, carrying streams of fluids between large chemical processing units. Many of the processes utilized in oil refineries create large quantities of gas. A substantial quantity of this gas is negative-value gas, i.e. there is financial loss incurred in disposing of the gas. Much of the gas produced in a refinery is sent to a gas plant which serves to create value-added products or otherwise treat the gas before its use as a fuel gas or flaring of the gas to the environment. Flaring may be undesirable due to environmental regulations. Additionally, crude oil is often discovered with associated gas which is generally separated therefrom prior to refining of the crude oil. Other types of negative-value gases (e.g., coker gas, hydrofinishing gas) are also most commonly flared, and thus not optimally utilized.

Accordingly, there is a need in industry to improve the production of desirable hydrocarbons via hydrocracking of hydrocarbonaceous feedstock.

The term associated gas, also referred to as “casinghead” gas is used to describe gas that is extracted from wells along with hydrocarbon liquids. They represent the lighter chemical fraction (shorter molecular chain) formed when organic remains are converted into hydrocarbons. Such hydrocarbon gases may exist separately from the crude oil in the underground formation or be dissolved in the crude oil. As the crude oil is raised from the reservoir to the surface, pressure is reduced to atmospheric, and the dissolved hydrocarbon gases come out of solution.

Often, due to the remote location of many oil fields, associated gas cannot be economically gathered from wells and transported to end-use applications and as a result is flared or in other instances vented to the atmosphere. This is an environmental concern as flaring increases CO2 emissions and contributes to global warming and is a waste of natural resources. Due to environmental concerns the flaring of associated gas is under increasing regulations from governments. Some alternatives exist for capture and/or transport of associated gases. Capturing and compressing natural gas (CNG) is expensive and requires significant energy for gas compression. Compression pressures up to about 3,500 psig are required for transport.

There, therefore, exists a need for more economical ways to utilize associated gas and reduce the environmental impact of venting and flaring.

### SUMMARY

Herein disclosed is a method for hydrogenation comprising: supersaturating a hydrocarbonaceous liquid or slurry stream in a high shear device with a gas stream comprising hydrogen and optionally one or more C1-C6 hydrocarbons to form a supersaturated dispersion; and introducing the supersaturated dispersion into a reactor in the presence of a hydrogenation catalyst to generate a product stream.

In some embodiments, the catalyst is present as a slurry or a fluidized or fixed bed of catalyst. In some embodiments, the hydrogenation catalyst is mixed with the hydrocarbonaceous liquid or slurry stream and the gas stream in the high shear device. In some embodiments, the method further comprises recycling at least a portion of an off gas from the reactor, recycling at least a portion of the product stream from the reactor, or both. In some embodiments, the off gas comprises hydrogen, and optionally one or more C1-C6 hydrocarbons, and wherein the off gas is introduced into the high shear device.

In some embodiments, the product stream comprises an improved product distribution of hydrocarbon compounds, wherein improved product distribution refers to a higher content of C3+ hydrocarbons compared to the totality of feed streams. In some embodiments, the liquid or slurry stream comprises bitumen, tar sand, asphaltene, or a combination thereof. In some embodiments, the liquid or slurry stream comprises a petroleum, animal, or plant derived hydrocarbon. In some embodiments, the liquid or slurry stream comprises at least one component selected from the group consisting of coker bottoms, reduced crudes, recycle oils, fluid catalytic cracking (FCC) bottoms, crude petroleum, vacuum tower residua, coker gas oils, cycle oils, vacuum gas oils, deasphalted residua, heavy oils, coal derived oils, vacuum distillation residua, heavy naphthas, kerosenes, refractory catalytically cracked cycle stocks, high boiling virgin, and combinations thereof.

In some embodiments, the dispersion is up to 50% supersaturated. In some embodiments, supersaturation promotes the formation of desired product distribution in the reactor product stream. In some embodiments, supersaturation under high shear promotes free radical formation and free radical reactions.

In some embodiments, forming the supersaturated dispersion comprises utilizing a shear rate of greater than about 20,000 s⁻¹. In some embodiments, the high shear device comprises at least one rotor-stator combination, and wherein the at least one rotor is rotated at a tip speed of at least 22.9 m/s (4,500 ft/min) during formation of the dispersion. In some embodiments, hydrogenation comprises hydrocracking. In some embodiments, hydrogenation comprises hydro-treating, hydro-finishing, hydro-desulfurization, or a combination thereof.

Herein also disclosed is a system for hydrogenation comprising: at least one high shear device configured to provide high shear action comprising: an inlet for a hydrocarbonaceous fluid stream, an optional inlet for a gas stream comprising hydrogen and optionally one or more C1-C6 hydrocarbons, an outlet for a supersaturated dispersion formed under the high shear action, and at least one generator comprising a rotor and a stator separated by a shear gap, wherein the shear gap is the minimum distance between the rotor and the stator; wherein the high shear mixing device is capable of producing a tip speed of the rotor of greater than 5.0 m/s (1,000 ft/min); and a reactor comprising an inlet fluidly connected to the outlet of the high shear device and an outlet for a product stream comprising an improved product distribution of hydrocarbon compounds.

In some embodiments, the system further comprises a separator downstream of the reactor. In some embodiments, the system further comprises a fractionator downstream of the reactor. In some embodiments, the at least one high shear device is capable of producing a tip speed of at least 22.9 m/s. In some embodiments, the at least one high shear device is capable of producing a tip speed of at least 40.1 m/s. In some embodiments, the at least one high shear device comprises at least two generators. In some embodiments, the high shear device is configured to produce a shear rate of greater than 20,000 s⁻¹, wherein the shear rate is the tip speed of the rotor divided by the shear gap.

Further disclosed herein is a method comprising mixing an associated gas with a hydrocarbon liquid in a high shear device to produce a supersaturated dispersion; and transporting the supersaturated dispersion. In some embodiments, the high shear device is positioned in proximity to an oil production well. In some embodiments, the supersaturated dispersion is produced via free radical reactions. In some embodiments, the supersaturated dispersion is produced under the action of a catalyst. In some embodiments, the method further comprises desulfurizing the hydrocarbon liquid. In some embodiments, the method further comprises hydrotreating the hydrocarbon liquid. In some embodiments, wherein the supersaturated dispersion is transported in an existing pipeline. In some embodiments, the method comprises utilizing more than one high shear device along the pipeline to maintain or enhance supersaturation of the gas in the liquid.

The foregoing has outlined rather broadly the features and technical advantages of the present invention in order that the detailed description of the invention that follows may be better understood. Additional features and advantages of the invention will be described hereinafter that form the subject of the claims of the invention. These and other embodiments and potential advantages will be apparent given the following detailed description and drawings. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more detailed description of the preferred embodiment of the present invention, reference will now be made to the accompanying drawings, wherein:

FIGS. 1A, 1B, and 1C illustrate various embodiments of the present disclosure, for an improved hydrocracking process, to produce an improved product distribution of hydrocarbon compounds.

FIG. 1D is a process flow diagram illustrating an improved hydrocracking/hydrogenation system according to an embodiment of this disclosure.

FIG. 2 is a longitudinal cross-section view of a multi-stage high shear device, as employed in an embodiment of the present disclosure.

FIG. 3 illustrates a configuration of the high shear device used to incorporate associated gases into hydrocarbon liquids, in accordance with an embodiment of this disclosure.

### NOTATION AND NOMENCLATURE

As used herein, the term “dispersion” refers to a liquefied mixture that contains at least two distinguishable substances (or “phases”) that will not readily mix and dissolve together. As used herein, a “dispersion” comprises a “continuous” phase (or “matrix”), which holds therein discontinuous droplets, bubbles, and/or particles of the other phase or substance. The term dispersion may thus refer to foams comprising gas bubbles suspended in a liquid continuous phase, emulsions in which droplets of a first liquid are dispersed throughout a continuous phase comprising a second liquid with which the first liquid is immiscible, and continuous liquid phases throughout which solid particles are distributed. As used herein, the term “dispersion” encompasses continuous liquid phases throughout which gas bubbles are distributed, continuous liquid phases throughout which solid particles (e.g., solid catalyst) are distributed, continuous phases of a first liquid throughout which droplets of a second liquid that is substantially insoluble in the continuous phase are distributed, and liquid phases throughout which any one or a combination of solid particles, immiscible liquid droplets, and gas bubbles are distributed. Hence, a dispersion can exist as a homogeneous mixture in some cases (e.g., liquid/liquid phase), or as a heterogeneous mixture (e.g., gas/liquid, solid/liquid, or gas/solid/liquid), depending on the nature of the materials selected for combination.

As used herein, the term “hydrocracking” means a process which consumes hydrogen and converts a hydrocarbonaceous stream, such as a petroleum fraction, to a hydrocarbon product, in which at least a portion of the high molecular weight compounds in the feed are cracked to lower boiling materials. As used herein the term hydrocracking can include any chemical or petrochemical reaction that reacts hydrogen with hydrocarbon to either reduce unsaturation, reduce sulfur content, reduce aromatic to aliphatic compounds and/or reduce molecular weight of petrochemical compounds.

As used herein “reforming” refers to initiation reactions, where a single molecule breaks apart into two free radicals with the predominant reaction being the breaking of a bond between a carbon and a hydrogen atom. This can be through several mechanisms and result in several types of end products as follows:

CH₃CH₃→2CH₃. (1)

The resulting radical can further result in hydrogen abstraction where a free radical removes a hydrogen atom from another molecule, turning the second molecule into a free radical.

CH₃.+CH₃CH₃→CH₄+CH₃CH₂. (2)

Alternatively radical decomposition can occurs where a free radical breaks apart into two molecules, one an alkene, the other a free radical.

CH₃CH₂.→CH₂═CH₂+H. (3)

Radical addition, the reverse of radical decomposition, occurs when a radical reacts with an alkene to form a single, larger free radical. These processes can result in forming aromatic products that result when heavier feedstocks are used. Formation of aromatics from free radical processes can occur once the polymer chains reach a certain length, and the reaction temperature and pressure are at suitable conditions, whereby the polymer chain will coil, and cyclize. Subsequent dehydrogenation can occur to produce an aromatic compound.

CH₃CH₂.+CH₂═CH₂→CH₃CH₂CH₂CH₂. (4)

Termination reactions can occur when two free radicals react with each other to produce products that are not free radicals. Two common forms of termination are combination (5), where the two radicals combine to form one larger molecule, and disproportionation (6), where one radical transfers a hydrogen atom to the other, giving an alkene and an alkane.

CH₃.+CH₃CH₂.→CH₃CH₂CH₃ (5)

CH₃CH₂.+CH₃CH₂.→CH₂═CH₂+CH₃CH₃ (6)

Two or more extracted hydrogen radicals may also combine.

As used herein, the term “gas oil” refers to a hydrocarbon oil used as a fuel oil, for example a petroleum distillate intermediate in boiling range and viscosity between kerosene and lubricating oil.

In this disclosure, supersaturation means that the dispersion (or the solvent or continuous phase) contains an amount of solute or discontinuous phase more than the amount of solute or discontinuous phase at equilibrium state when compared at the same condition. The percentage of the excess amount of solute or discontinuous phase is a measure of the degree of supersaturation of the dispersion. The solute or discontinuous phase may be either dissolved in the solvent or incorporated in the continuous phase (e.g., small gas bubbles unrecognizable to the naked eye). The supersaturated dispersion includes the totality of the solvent or continuous phase and all states of solute or discontinuous phase. When the solute is gas, the level of supersaturation is referred to in volume %. When the solute is liquid or solid, the level of supersaturation is referred to in weight %.

With respect to hydrocracking, the activity, stability and selectivity, as utilized herein, may be defined as follows: “activity” refers to the quantity of the feedstock boiling above a given temperature which is converted to hydrocarbons boiling below the given temperature; “selectivity” refers to the quantity of converted feedstock which boils below the desired end point of the product, and above a minimum specified initial boiling point; and “stability” refers to the rate of change of activity and selectivity.

### DETAILED DESCRIPTION

Overview.

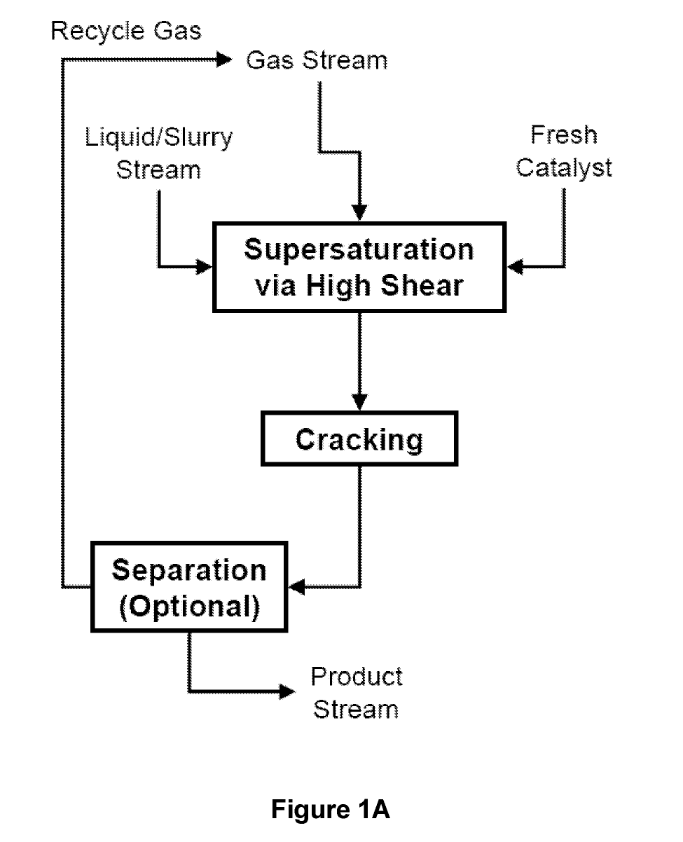

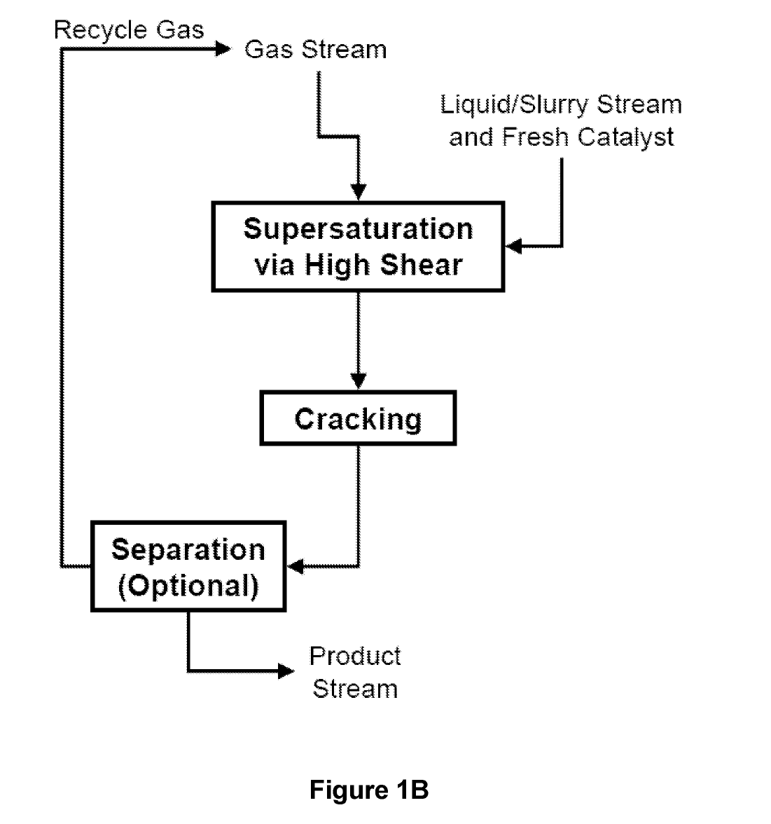

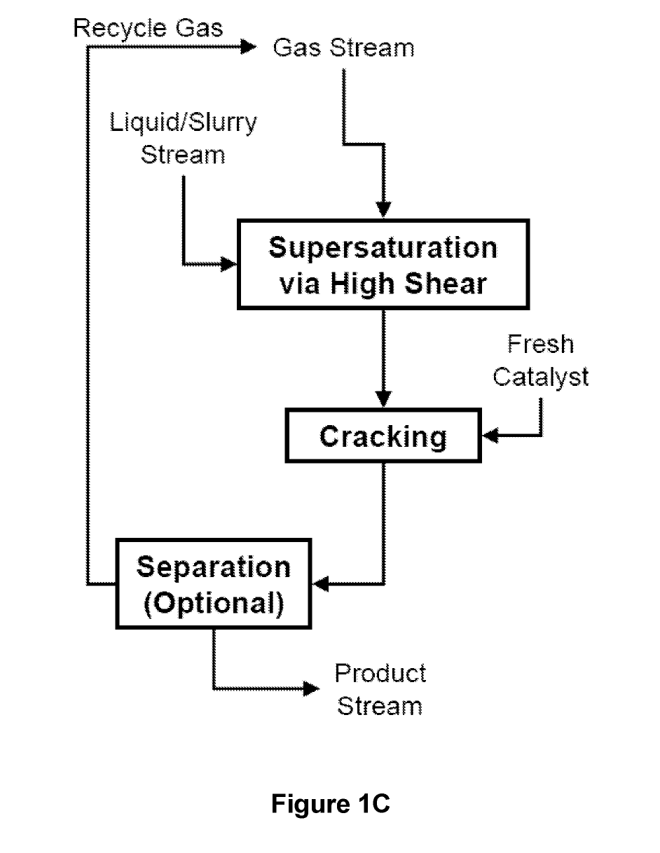

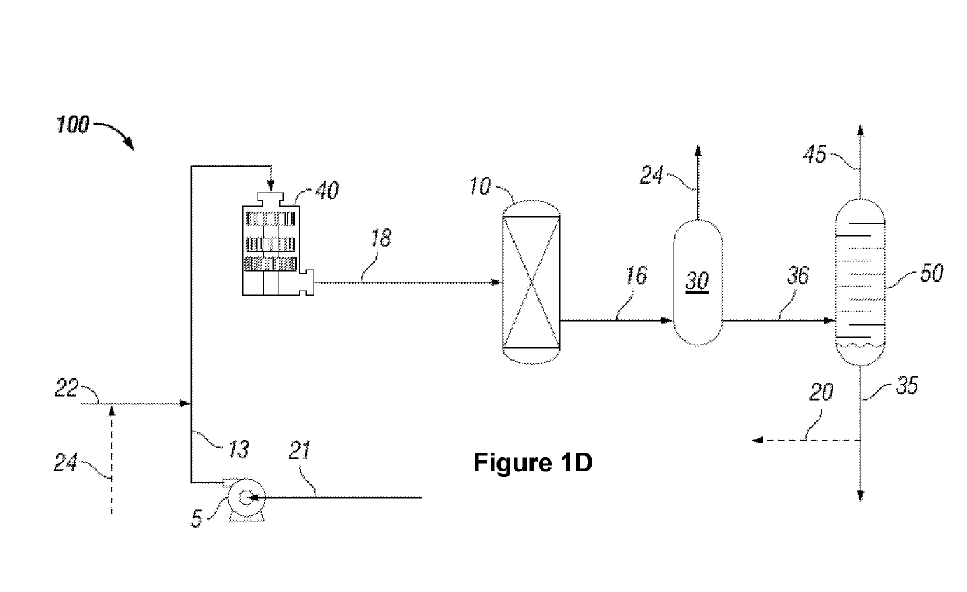

In various embodiments of this disclosure, as illustrated by FIGS. 1A-1C, a gas stream comprising hydrogen and optionally at least one or more hydrocarbons selected from C1-C6 is mixed with a liquid or slurry hydrocarbon stream in a high shear device to form a supersaturated dispersion. The supersaturated dispersion is then introduced into a cracking unit to produce a product stream under the action of a suitable catalyst. The product stream comprises improved product distribution of hydrocarbon compounds. In the case of hydrocracking, improved product distribution refers to a higher content of C3+ hydrocarbons compared to the totality of feed streams, including components for gasoline, diesel, jet fuel, asphalt base, heating oil, kerosene, and/or liquefied petroleum gas. In the case of hydrogenation, improved product distribution refers to a higher content of hydrocarbon saturation (i.e., single C—C bonds) and/or a lower content of impurities. In embodiments, the improved product distribution includes both aliphatic and aromatic compounds.

The action of high shear promotes the supersaturation/incorporation of the gas components in the formed dispersion. Without wishing to be limited by theory, the high shear action also produces free radicals in the dispersion to initiate free radical reactions. Furthermore, without wishing to be limited by theory, it is believed that the high shear action provided by a high shear device or mixer as described herein may permit hydrocracking at global operating conditions under which reaction may not conventionally be expected to occur to any significant extent. Further details of the improved system and method are described herein below.

Improved Hydrocracking.

In an embodiment, FIG. 1A illustrates an improved hydrocracking process. A gas stream comprising hydrogen and optionally at least one or more hydrocarbons selected from C1-C6 is mixed with a liquid or slurry hydrocarbon stream in a high shear device to form a supersaturated dispersion. In an embodiment, the C1-C6 component includes one or more of methane, ethane, propane, and butane. In an embodiment, the dispersion is 5% supersaturated. In an embodiment, the dispersion is up to or at least 10% supersaturated. In an embodiment, the dispersion is up to or at least 20% supersaturated. In an embodiment, the dispersion is up to or at least 30% supersaturated. In an embodiment, the dispersion is up to or at least 40% supersaturated. In an embodiment, the dispersion is up to or at least 50% supersaturated.

In an embodiment, the liquid/slurry stream comprises bitumen. In an embodiment, the liquid/slurry stream comprises tar sand. In an embodiment, the liquid/slurry stream comprises gas oils. In an embodiment, the liquid/slurry stream comprises coker bottoms. In an embodiment, the liquid/slurry stream comprises reduced crudes. In an embodiment, the liquid/slurry stream comprises recycle oils. In an embodiment, the liquid/slurry stream comprises fluid catalytic cracking (FCC) bottoms. In an embodiment, the liquid/slurry stream comprises crude petroleum, reduced crudes (coker tower bottoms fraction reduced crude), vacuum tower residua, coker gas oils, cycle oils, FCC tower bottoms, vacuum gas oils, deasphalted (vacuum) residua, other heavy oils, bitumen, and/or tar sand. In an embodiment, the liquid/slurry stream comprises Maracaibo heavy crude. In embodiments, the liquid/slurry stream comprises vacuum gas oil, gas oil, heavy oil, reduced crude, vacuum distillation residua, or a combination thereof. In an embodiment, the liquid/slurry stream comprises one or more of heavy naphthas, kerosenes, refractory catalytically cracked cycle stocks, and high boiling virgin and coker gas oils. In embodiments, the liquid/slurry stream comprises a petroleum, animal and/or vegetable derived hydrocarbon.

In an embodiment, the liquid/slurry stream comprises asphaltene. In some cases, the asphaltene is comminuted prior to incorporation in the liquid/slurry stream. Asphaltenes are found in heavy fuel oils and bitumen, and are generally defined as insoluble solids in the hydrocarbon. Without wishing to be limited by theory, hydrogenation of the asphaltenes takes place via free radical reactions as disclosed herein. In some embodiments, the high shear action provides comminution of the asphaltene particles, in combination with hydrogenation that provides decomposition products that may include aliphatic compounds. In some embodiments, asphaltenes are hydrogenated by the use of catalyst such as Ni—Mo and other catalysts known to one skilled in the art.

In an embodiment, hydrogen is produced that might otherwise be produced in petroleum processing plants by steam reforming.

The liquid or slurry hydrocarbon stream is optionally cleaned or detoxified (not shown in FIG. 1A) prior to high shear mixing so that impurities harmful to the hydrocracking process are reduced. Such harmful impurities include, without limitation, various sulfur and nitrogen species. Methods and systems for such cleaning are known to one skilled in the art. For example, the liquid/slurry stream may be preheated, mixed with recycled hydrogen, and sent to a reactor, wherein catalytic conversion of sulfur and nitrogen compounds to extractable hydrogen sulfide and ammonia is effected.

In an embodiment, the high shear creates radical hydrogen and hydrogenates in the supersaturated dispersion before it is introduced into a downstream device (e.g., a cracking unit, FCC, hydrocracker).

The supersaturated dispersion is then introduced into a cracking unit to produce a product stream under the action of a suitable catalyst. The product stream comprises improved product distribution of hydrocarbon compounds. Improved product distribution refers to a higher content of C3+ hydrocarbons compared to the totality of the feed stream(s). In various embodiments, the content of components for gasoline, diesel, jet fuel, asphalt base, heating oil, kerosene, and liquefied petroleum gas in the product stream is increased relative to that of the totality of the feed stream(s).

In some embodiments, the tail gas or off gas from the hydrocracking or hydrogenation unit is recycled to the feed gas stream for multi-pass operation. In an embodiment, the tail gas or off gas from the cracking unit comprises hydrogen. In an embodiment, the tail gas or off gas from the cracking unit comprises one or more hydrocarbons selected from C1-C6.

In an embodiment, the outlet stream from the hydrocracking or hydrogenation unit optionally passes through a separation system as needed or desired. In some cases, as indicated in the figures, the product stream comprising value-added compounds is separated from the off gas (or recycle gas). In some cases, catalyst is separated for reuse (not shown). In some cases, hydrogen is separated for reuse (not shown). Such separation systems and methods are known to one skilled in the art, and thus various arrangements of separation are deemed to be within the scope of this disclosure.

A hydrocracking catalyst may be added in different ways. In the embodiment shown in FIG. 1A, fresh or make-up catalyst is mixed with the gas stream and the liquid/slurry stream in the high shear device. In the embodiment shown in FIG. 1B, fresh or make-up catalyst is mixed with the liquid/slurry stream prior to introduction to the high shear device. In the embodiment shown in FIG. 1C, fresh or make-up catalyst is introduced directly into the cracking or hydrogenation unit.

Improved Hydrocracking System.

In an embodiment as illustrated in FIG. 1D, the basic components of an improved hydrocracking system 100 include external high shear device (or ‘HSD’) 40, cracker or reactor 10, and pump 5. As shown in FIG. 1D, high shear device 40 is located external to reactor 10. Each of these components is further described in more detail below. Line 21 is connected to pump 5 for introducing hydrocarbonaceous fluid to be hydrocracked/hydrogenated. Line 13 connects pump 5 to HSD 40, and line 18 connects HSD 40 to reactor 10. Line 22 may be connected to line 13 for introducing the gas stream, e.g., a gas stream comprising H₂. In embodiments of high shear hydrocracking system 100, line 22 fluidly connects to an inlet of HSD 40. In some embodiments, a holding tank is present between the HSD 40 and the reactor 10 (not shown).

High shear hydrocracking system 100 may further comprise downstream processing units by which hydrocracked liquid product exiting reactor 10 is separated from uncracked heavy oil. For example, in the embodiment of FIG. 1D, high shear hydrocracking system 100 further comprises separator 30 and fractionator 50. Separator 30 may be fluidly connected via line 16 to reactor 10 and via line 36 to fractionator 50. Gas line 24 may exit separator 30 as indicated in FIG. 1D. Separator 30 may comprise a high pressure separator from which hydrogen and light gases are removed from liquid product comprising hydrocracked hydrocarbons. Fractionator 50 may be adapted to separate hydrocracked product which may exit fractionator 50 via overhead line 45, from heavy and/or unconverted oil, which may exit the bottom of fractionator 50 via line 35. Fractionator 50 may be a fractional distillation column.

Additional components or process steps may be incorporated between reactor 10 and HSD 40, or ahead of pump 5 or HSD 40, if desired (not shown in FIG. 1D), as will become apparent upon reading the description of the high shear hydrocracking process described hereinbelow. For example, if desired, line 20 may be connected to line 21 and/or line 13 from a downstream location (e.g., from reactor 10, separator 30, and/or fractionator 50), to provide for multi-pass operation and hydrocracking of at least a portion of the unconverted and/or heavy hydrocarbon exiting reactor 10. In embodiments, lines 20 and 21 are a single line.

High Shear Device.

External high shear device (HSD) 40, also sometimes referred to as a high shear mixing device, is configured for receiving an inlet stream, via line 13, comprising e.g., hydrogen gas and hydrocarbonaceous liquid containing higher molecular weight hydrocarbons to be hydrocracked to lower boiling point compounds. Alternatively, HSD 40 may be configured for receiving the liquid/slurry and gaseous reactant streams via separate inlet lines (not shown). Although only one high shear device is shown in FIG. 1D, it should be understood that some embodiments of the system may incorporate two or more high shear mixing devices, arranged in series flow, in parallel flow, or a combination thereof. HSD 40 is a mechanical device that utilizes one or more generator comprising a rotor/stator combination, each of which has a gap between the stator and rotor. The gap between the rotor and the stator in each generator set may be fixed or may be adjustable. HSD 40 is configured in such a way that it is capable of producing submicron and micron-sized bubbles in a reactant mixture flowing through the high shear device. The high shear device comprises an enclosure or housing so that the pressure and temperature of the reaction mixture may be controlled.

High shear mixing devices are generally divided into three general classes, based upon their ability to mix fluids. Mixing is the process of reducing the size of particles or inhomogeneous species within the fluid. One metric for the degree or thoroughness of mixing is the energy density per unit volume that the mixing device generates to disrupt the fluid particles. The classes are distinguished based on delivered energy densities. Three classes of industrial mixers having sufficient energy density to consistently produce mixtures or emulsions with particle sizes in the range of submicron to 50 microns are homogenization valve systems, colloid mills and high speed mixers. In the first class of high energy devices, referred to as homogenization valve systems, fluid to be processed is pumped under very high pressure through a narrow-gap valve into a lower pressure environment. The pressure gradients across the valve, and the resulting turbulence and cavitation act to break-up particles in the fluid. These valve systems are most commonly utilized in milk homogenization, and can yield average particle sizes in the submicron to about 1 micron range.

At the opposite end of the energy density spectrum is the third class of devices referred to as low energy devices. These systems typically employ paddles or fluid rotors that turn at high speed in a reservoir of fluid to be processed, which in many of the more common applications is a food product. These low energy systems are customarily used when average particle sizes of greater than 20 microns are acceptable in the processed fluid.

Between the low energy devices and homogenization valve systems, in terms of the mixing energy density delivered to the fluid, are colloid mills and other high speed rotor-stator devices, which are classified as intermediate energy devices. A typical colloid mill configuration includes a conical or disk rotor that is separated from a complementary, liquid-cooled stator by a closely-controlled rotor-stator gap, which is commonly between 0.0254 mm to 10.16 mm (0.001-0.inch). Rotors are usually driven by an electric motor through a direct drive or belt mechanism. As the rotor rotates at high rates, it pumps fluid between the outer surface of the rotor and the inner surface of the stator, and shear forces generated in the gap process the fluid. Many colloid mills with proper adjustment achieve average particle sizes of 0.1-25 microns in the processed fluid. These capabilities render colloid mills appropriate for a variety of applications, including colloid and oil/water-based emulsion processing such as that required for cosmetics, mayonnaise, and silicone/silver amalgam formation, to roofing-tar mixing.

Tip speed is the circumferential distance traveled by the tip of the rotor per unit of time. Tip speed is thus a function of the rotor diameter and the rotational frequency. Tip speed (in meters per minute, for example) may be calculated by multiplying the circumferential distance transcribed by the rotor tip, 2πR, where R is the radius of the rotor (meters, for example) times the frequency of revolution (for example revolutions per minute, rpm). A colloid mill, for example, may have a tip speed in excess of 22.9 m/s (4500 ft/min) and may exceed m/s (7900 ft/min). For the purpose of this disclosure, the term ‘high shear’ refers to mechanical rotor stator devices (e.g., colloid mills or rotor-stator dispersers) that are capable of tip speeds in excess of 5.1 m/s. (1000 ft/min) and require an external mechanically driven power device to drive energy into the stream of products to be reacted. For example, in HSD 40, a tip speed in excess of 22.9 m/s (4500 ft/min) is achievable, and may exceed 40 m/s (7900 ft/min). In some embodiments, HSD is capable of delivering at least 300 L/h at a tip speed of at least 22.9 m/s (4500 ft/min). The power consumption may be about 1.5 kW. HSD combines high tip speed with a very small shear gap to produce significant shear on the material being processed. The amount of shear will be dependent on the viscosity of the fluid. Accordingly, a local region of elevated pressure and temperature is created at the tip of the rotor during operation of the high shear device. In some cases, the locally elevated pressure is about 1034.2 MPa (150,000 psi). In some cases the locally elevated temperature is about 500° C. In some cases, these local pressure and temperature elevations may persist for nano or pico seconds.

An approximation of energy input into the fluid (kW/L/min) can be estimated by measuring the motor energy (kW) and fluid output (L/min). As mentioned above, tip speed is the velocity (ft/min or m/s) associated with the end of the one or more revolving elements that is creating the mechanical force applied to the reactants. In embodiments, the energy expenditure of HSD is greater than 1000 W/m³. In embodiments, the energy expenditure of HSD is in the range of from about 3000 W/m³ to about 7500 W/m³. In embodiments in which slurry-based catalyst is circulated through HSD 40, it may be desirable to utilize revolving elements which are made of a durable material, such as ceramic.

The shear rate is the tip speed divided by the shear gap width (minimal clearance between the rotor and stator). The shear rate generated in HSD may be greater than 20,000 s⁻¹. In some embodiments the shear rate is at least 40,000 s⁻¹. In some embodiments the shear rate is at least 100,000 s⁻¹. In some embodiments the shear rate is at least 500,000 s⁻¹. In some embodiments the shear rate is at least 1,000,000 s⁻¹. In some embodiments the shear rate is at least 1,600,000 s⁻¹. In embodiments, the shear rate generated by HSD is in the range of from 20,000 s⁻¹ to 100,000 s⁻¹. For example, in one application the rotor tip speed is about 40 m/s (7900 ft/min) and the shear gap width is 0.0254 mm (0.001 inch), producing a shear rate of 1,600,000 s⁻¹. In another application the rotor tip speed is about 22.9 m/s (4500 ft/min) and the shear gap width is 0.0254 mm (0.001 inch), producing a shear rate of about 901,600 s⁻¹.

HSD 40 is capable of highly dispersing or transporting hydrogen into a main liquid phase (continuous phase) comprising hydrocarbonaceous fluid, with which it would normally be immiscible, at conditions such that a dispersion of hydrogen in continuous liquid phase is produced and exits HSD 40 via line 18. It is envisioned that, in embodiments, the hydrocarbonaceous fluid further comprises a catalyst which is circulated about high shear hydrocracking system 100. In some embodiments, the HSD comprises a colloid mill. Suitable colloidal mills are manufactured by IKA® Works, Inc. Wilmington, N.C. and APV North America, Inc. Wilmington, Mass., for example. In some instances, HSD comprises the DISPAX REACTOR® of IKA® Works, Inc.

The high shear device comprises at least one revolving element that creates the mechanical force applied to the reactants. The high shear device comprises at least one stator and at least one rotor separated by a clearance. For example, the rotors may be conical or disk shaped and may be separated from a complementarily-shaped stator. In embodiments, both the rotor and the stator comprise a plurality of circumferentially-spaced teeth. In some embodiments, the stator(s) are adjustable to obtain the desired shear gap between the rotor and the stator of each generator (rotor/stator set). Grooves between the teeth of the rotor and/or the stator may alternate direction in alternate stages for increased turbulence. Each generator may be driven by any suitable drive system configured for providing the desired rotation.

In some embodiments, the minimum clearance (shear gap width) between the stator and the rotor is in the range of from about 0.0254 mm (0.001 inch) to about 3.175 mm (0.125 inch). In certain embodiments, the minimum clearance (shear gap width) between the stator and the rotor is about 1.52 mm (0.060 inch). In certain configurations, the minimum clearance (shear gap) between the rotor and the stator is at least 1.78 mm (0.07 inch). The shear rate produced by the high shear device may vary with longitudinal position along the flow pathway. In some embodiments, the rotor is set to rotate at a speed commensurate with the diameter of the rotor and the desired tip speed. In some embodiments, the high shear device has a fixed clearance (shear gap width) between the stator and rotor. Alternatively, the high shear device has adjustable clearance (shear gap width).

In some embodiments, HSD comprises a single stage dispersing chamber (i.e., a single rotor/stator combination, a single generator). In some embodiments, high shear device is a multiple stage inline disperser and comprises a plurality of generators. In certain embodiments, HSD comprises at least two generators. In other embodiments, high shear device comprises at least 3 high shear generators. In some embodiments, high shear device is a multistage mixer, whereby the shear rate (which, as mentioned above, varies proportionately with tip speed and inversely with rotor/stator gap width) varies with longitudinal position along the flow pathway, as further described herein below.

In some embodiments, each stage of the external high shear device has interchangeable mixing tools, offering flexibility. For example, the DR 2000/4 DISPAX REACTOR® of IKA® Works, Inc. Wilmington, N.C. and APV North America, Inc. Wilmington, Mass., comprises a three stage dispersing module. This module may comprise up to three rotor/stator combinations (generators), with choice of fine, medium, coarse, and super-fine for each stage. This allows for creation of dispersions having a narrow distribution of the desired bubble size (e.g., hydrogen gas bubbles). In some embodiments, each of the stages is operated with a super-fine generator. In some embodiments, at least one of the generator sets has a rotor/stator minimum clearance (shear gap width) of greater than about 5.08 mm (0.20 inch). In alternative embodiments, at least one of the generator sets has a minimum rotor/stator clearance of greater than about 1.78 mm (0.07 inch).

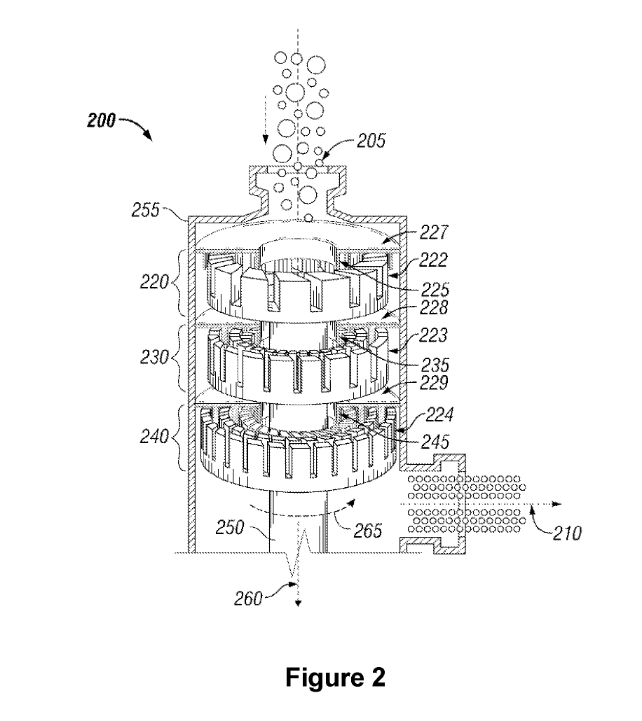

Referring now to FIG. 2, there is presented a longitudinal cross-section of a suitable high shear device 200. High shear device 200 of FIG. 2 is a dispersing device comprising three stages or rotor-stator combinations. High shear device 200 is a dispersing device comprising three stages or rotor-stator combinations, 220, 230, and 240. The rotor-stator combinations may be known as generators 220, 230, 240, or stages without limitation. Three rotor/stator sets or generators 220, 230, and 240 are aligned in series along drive shaft 250.

First generator 220 comprises rotor 222 and stator 227. Second generator 230 comprises rotor 223, and stator 228. Third generator 240 comprises rotor 224 and stator 229. For each generator the rotor is rotatably driven by input/drive shaft 250 and rotates about axis 260 as indicated by arrow 265. The direction of rotation may be opposite that shown by arrow 265 (e.g., clockwise or counterclockwise about axis of rotation 260). Stators 227, 228, and 229 are fixably coupled to the wall 255 of high shear device 200.

As mentioned hereinabove, each generator has a shear gap width which is the minimum distance or minimum clearance between the rotor and the stator. In the embodiment of FIG. 2, first generator 220 comprises a first shear gap 225; second generator 230 comprises a second shear gap 235; and third generator 240 comprises a third shear gap 245. In embodiments, shear gaps 225, 235, 245 have widths in the range of from about 0.025 mm to about 10.0 mm. Alternatively, the process comprises utilization of a high shear device 200 wherein the gaps 225, 235, 245 have a width in the range of from about 0.5 mm to about 2.5 mm. In certain instances the shear gap width is maintained at about 1.5 mm. Alternatively, the width of shear gaps 225, 235, 245 are different for generators 220, 230, 240. In certain instances, the width of shear gap 225 of first generator 220 is greater than the width of shear gap 235 of second generator 230, which is in turn greater than the width of shear gap 245 of third generator 240. As mentioned above, the generators of each stage may be interchangeable, offering flexibility. High shear device 200 may be configured so that the shear rate increases stepwise longitudinally along the direction of the flow 260.

Generators 220, 230, and 240 may comprise a coarse, medium, fine, and super-fine characterization. Rotors 222, 223, and 224 and stators 227, 228, and 229 may be toothed designs. Each generator may comprise two or more sets of rotor-stator teeth. In embodiments, rotors 222, 223, and 224 comprise more than 10 rotor teeth circumferentially spaced about the circumference of each rotor. In embodiments, stators 227, 228, and 229 comprise more than ten stator teeth circumferentially spaced about the circumference of each stator. In embodiments, the inner diameter of the rotor is about 12 cm. In embodiments, the diameter of the rotor is about 6 cm. In embodiments, the outer diameter of the stator is about 15 cm. In embodiments, the diameter of the stator is about 6.4 cm. In some embodiments the rotors are 60 mm and the stators are 64 mm in diameter, providing a clearance of about 4 mm. In certain embodiments, each of three stages is operated with a super-fine generator, comprising a shear gap of between about 0.025 mm and about 4 mm. For applications in which solid particles are to be sent through high shear device 40, the appropriate shear gap width (minimum clearance between rotor and stator) may be selected for an appropriate reduction in particle size and increase in particle surface area. In embodiments, this may be beneficial for increasing catalyst surface area by shearing and dispersing the particles.

High shear device 200 is configured for receiving from line 13 a reactant stream at inlet 205. The reaction mixture comprises hydrogen as the dispersible phase and hydrocarbonaceous liquid as the continuous phase. The feed stream may further comprise a particulate solid catalyst component. Feed stream entering inlet 205 is pumped serially through generators 220, 230, and then 240, such that product dispersion is formed. Product dispersion exits high shear device 200 via outlet 210. The rotors 222, 223, 224 of each generator rotate at high speed relative to the fixed stators 227, 228, 229, providing a high shear rate. The rotation of the rotors pumps fluid, such as the feed stream entering inlet 205, outwardly through the shear gaps (and, if present, through the spaces between the rotor teeth and the spaces between the stator teeth), creating a localized high shear condition. High shear forces exerted on fluid in shear gaps 225, 235, and 245 (and, when present, in the gaps between the rotor teeth and the stator teeth) through which fluid flows process the fluid and create product dispersion. Product dispersion exits high shear device 200 via high shear outlet 210.

The product dispersion has an average gas bubble size less than about 5 μm. In embodiments, HSD produces a dispersion having a mean bubble size of less than about 1.5 μm. In embodiments, HSD produces a dispersion having a mean bubble size of less than 1 μm; in embodiments, the bubbles are primarily or substantially sub-micron in diameter. In certain instances, the average bubble size is in the range of from about 0.1 μm to about 1.0 μm. In embodiments, HSD produces a dispersion having a mean bubble size of less than 400 nm. In embodiments, HSD produces a dispersion having a mean bubble size of less than 100 nm. High shear device 200 produces a dispersion comprising dispersed gas bubbles capable of remaining dispersed at atmospheric pressure for at least about 15 minutes.

Not to be limited by theory, it is known in emulsion chemistry that sub-micron particles, or bubbles, dispersed in a liquid undergo movement primarily through Brownian motion effects. The bubbles in the product dispersion created by high shear device 200 may have greater mobility through boundary layers of solid catalyst particles (for example, through solid catalyst in a reactor), thereby facilitating and accelerating the catalytic reaction through enhanced transport of reactants.

In certain instances, high shear device 200 comprises a DISPAX REACTOR® of IKA® Works, Inc. Wilmington, N.C. and APV North America, Inc. Wilmington, Mass. Several models are available having various inlet/outlet connections, horsepower, tip speeds, output rpm, and flow rate. Selection of the high shear device will depend on throughput requirements and desired particle or bubble size in dispersion exiting outlet 210 of high shear device 200. IKA® model DR 2000/4, for example, comprises a belt drive, 4M generator, polytetrafluoroethylene (PTFE) sealing ring, inlet flange 25.4 mm (1 inch) sanitary clamp, outlet flange 19 mm (¾inch) sanitary clamp, 2 HP power, output speed of 7900 rpm, flow capacity (water) approximately 300-700 L/h (depending on generator), a tip speed of from 9.4-41 m/s (1850 ft/min to 8070 ft/min).

Cracker or Reactor.

In embodiments, a cracking unit is a cracker or vessel or reactor of any type in which hydrocracking can propagate. For instance, a continuous or semi-continuous stirred tank reactor, or one or more batch reactors may be employed in series or in parallel. In applications reactor 10 is a fixed bed reactor. In embodiments, reactor 10 is a slurry bed reactor. Thus, in embodiments, reactor 10 comprises a fixed, uncirculated catalyst, and feedstream in line 21 comprises catalyst-free liquid hydrocarbon.

Any number of reactor 10 inlet streams is envisioned, with one (line 18) shown in FIG. 1D. In embodiments, reactor 10 is an extinction hydrocracking reactor. Reactor 10 may be either a single-stage “extinction” recycle reactor or the second-stage “extinction” recycle reactor of a two-stage hydrocracker. The conversion may be conducted by contacting the feedstock dispersion from line 18 with a fixed stationary bed of catalyst, a fixed fluidized bed of catalyst, or with a transport bed of catalyst. In embodiments, reactor 10 is a trickle-bed in which the feed dispersion is allowed to trickle through a stationary fixed bed of catalyst. With such a configuration, it may be desirable to initiate the reaction with fresh catalyst at a moderate temperature which may be raised as the catalyst ages, in order to maintain catalytic activity.

Reactor 10 may further comprise, for example, an inlet line for catalyst connected to reactor 10 for receiving a catalyst solution or slurry during operation of the system. Reactor 10 may comprise an exit line (not shown in FIG. 1D) for vent gas which may comprise unreacted gases (e.g., hydrogen). Reactor 10 comprises an outlet line 16 for a product stream comprising hydrocarbon product comprising lower boiling materials formed by cracking of at least a portion of the high molecular weight compounds in the liquid/slurry stream and/or by free radical reactions. In embodiments, reactor 10 comprises a plurality of reactor product lines 16.

Hydrocracking reactions will occur whenever suitable time, temperature and pressure conditions exist. In this sense, hydrocracking of high molecular weight compounds in the hydrocarbonaceous feedstream and/or free radical reactions may occur at any point in the flow diagram of FIG. 1D if temperature and pressure conditions are suitable. If a circulated slurry based catalyst is utilized, reaction may be more likely to occur at points outside reactor 10 shown of FIG. 1D. Nonetheless a discrete hydrocracking reactor 10 is often desirable to allow for increased residence time, agitation and heating and/or cooling. When a catalyst bed is utilized, reactor 10 may be a fixed bed reactor and may be the primary location for the hydrocracking to occur due to the presence of catalyst and its effect on the rate of hydrocracking. When reactor 10 is utilized, reactor 10 may be operated as slurry reactor, fixed bed reactor, trickle bed reactor, fluidized bed reactor, bubble column, or other method known to one of skill in the art. In some applications, the incorporation of external high shear device 40 will permit, for example, the operation of trickle bed reactors as slurry reactors.

Reactor 10 may include one or more of the following components: stirring system, heating and/or cooling capabilities, pressure measurement instrumentation, temperature measurement instrumentation, one or more injection points, and level regulator (not shown), as are known in the art of reaction vessel design. For example, a stirring system may include a motor driven mixer. A heating and/or cooling apparatus may comprise, for example, a heat exchanger.

Catalyst.

In embodiments, a suitable hydrocracking catalyst promotes a heterogeneous catalytic reaction involving a solid catalyst, gas and liquid/slurry hydrocarbonaceous phase. In embodiments, the catalyst can be categorized as a dual-function catalyst which possesses both hydrocracking (acid component) and hydrogenation activity. In embodiments, the catalyst comprises at least one metal selected from noble metals, such as platinum and palladium, and non-noble metals, such as nickel, cobalt, molybdenum, tungsten, iron, chromium, and combinations of these metals. In embodiments, the catalyst comprises a combination of metals, such as cobalt with molybdenum. In embodiments, hydrocracking is intended to be accompanied by some hydrorefining (desulfurization, denitrification, etc.) and the catalytic metallic component comprises nickel and molybdenum, or nickel and tungsten.

The hydrocracking catalysts may be employed with an inorganic oxide matrix component which may be selected, without limitation, from, for example, amorphous catalytic inorganic oxides, e.g., catalytically active silica-aluminas, clays, silicas, aluminas, magnesias, titanias, zirconias, silica-aluminas, silica-zirconias, silica-magnesias, alumina-borias, alumina-titanias and the like, and mixtures thereof. Although the catalyst may be subjected to chemical change in the reaction zone due to the presence therein of hydrogen and/or sulfur, the catalyst may be in the form of the oxide or sulfide when first brought into contact with the dispersion of hydrogen in the hydrocarbonaceous feedstream.

The acidic cracking component of the hydrocracking catalyst may be an amorphous material, such as, without limitation, an acidic clay, alumina, silica, and/or amorphous silica-alumina. Longer life catalyst may comprise a high amount of molecular sieve. Such catalysts with a higher degree of molecular sieve are the “zeolite” type catalysts. In conventional usage the term “molecular sieve” refers to a material having a fixed, open-network structure, usually crystalline, that may be used to separate hydrocarbons or other mixtures by selective occlusion of one or more of the constituents, or may be used as a catalyst in a catalytic conversion process. The term “zeolite” refers to a molecular sieve containing a silicate lattice, usually in association with some aluminum, boron, gallium, iron, and/or titanium.

In embodiments, the catalyst comprises an acidic cracking component comprising a zeolite. Large pore zeolites, such as zeolites X or Y, may be suitable because the principal components of the feedstocks (e.g., gas oils, coker bottoms, reduced crudes, recycle oils, FCC bottoms) are higher molecular weight hydrocarbons which will not enter the internal pore structure of smaller pore zeolites, and therefore may not undergo suitable conversion.

In some embodiments, the hydrocracking catalyst comprises an aluminosilicate component. Representative of the zeolitic aluminosilicates employable as component parts of hydrocracking catalysts are Zeolite Y (including steam stabilized, e.g., ultra-stable Y), Zeolite X, Zeolite beta, Zeolite ZK, Zeolite ZSM-3, faujasite, MCM-22, LZ, ZSM-5-type zeolites, e.g., ZSM-5, ZSM-11, ZSM-12, ZSM-23, ZSM-35, ZSM-38, ZSM-48, ZSM-20, crystalline silicates such as silicalite, erionite, mordenite, offretite, chabazite, FU-1-type zeolite, NU-type zeolites, LZ-210-type zeolite and mixtures thereof.

In embodiments, the catalyst comprises an amorphous material together with a crystalline zeolite, as described in U.S. Pat. No. 3,523,887. In embodiments, the catalyst is a catalyst as described in U.S. Pat. No. 5,391,287. Heavy hydrocarbon oils may be simultaneously hydrocracked and hydrodewaxed to produce a liquid product of satisfactory pour point and viscosity. This product may be obtained by the use of a catalyst comprising SSZ-35 zeolite. In embodiments, the hydrocarbonaceous feedstream in line 21 comprises heavy hydrocarbon oils [e.g., gas oil boiling above 343° C. (650° F.)], and a SSZ-35 zeolite catalyst is employed.

In embodiments, a reactor comprises a nickel hydrogenation catalyst, for example a catalyst according to U.S. Pat. No. 3,884,798, which is a coextruded catalytic composite of an alumina-containing porous carrier material and from about 6.5 to about 10.5% by weight of a nickel component, calculated as the elemental metal. This catalyst may be employed, for example, to obtain maximum production of LPG (liquefied petroleum gas) in the propane/butane range from hydrocarbonaceous feedstock comprising naphtha, and/or gasoline boiling range distillates. In embodiments, a nickel catalyst is used to convert heavier feedstocks, such as, without limitation, kerosenes, light gas oils, heavy gas oils, full boiling range gas oils and/or “black oils” into lower-boiling, normally liquid products, including, without limitation, gasolines, kerosenes, middle-distillates, lube oils, etc.

The catalyst may be regenerated by contact at elevated temperature with hydrogen gas, for example, or by burning in air or other oxygen-containing gas.

Heat Transfer Devices.

In addition to the above-mentioned heating/cooling capabilities of reactor 10, other external or internal heat transfer devices for heating or cooling a process stream are also contemplated in variations of the embodiments illustrated in FIGS. 1A-1D. For example, heat may be removed from or added to reactor 10 via any method known to one skilled in the art. The use of external heating and/or cooling heat transfer devices is also contemplated. Some suitable locations for one or more such heat transfer devices are between pump 5 and HSD 40, between HSD 40 and reactor 10, and upstream of pump 5. Some non-limiting examples of such heat transfer devices are shell, tube, plate, and coil heat exchangers, as are known in the art.

Pumps.

Pump 5 is configured for either continuous or semi-continuous operation, and may be any suitable pumping device that is capable of providing greater than 202.65 kPa (2 atm) pressure, or greater than 303.975 kPa (3 atm) pressure, to allow controlled flow through HSD 40 and system 100. Pump 5 may be capable of providing a pressure of greater than 7,000 kPa (69 atm). For example, a Roper Type 1 gear pump, Roper Pump Company (Commerce Ga.) Dayton Pressure Booster Pump Model 2P372E, Dayton Electric Co (Niles, Ill.) is one suitable pump. In embodiments, all contact parts of the pump comprise stainless steel, for example, 316 stainless steel. In some embodiments of the system, pump 5 is capable of pressures greater than about 2026.5 kPa (20 atm). In addition to pump 5, one or more additional pumps (not shown) may be included in the system illustrated in FIG. 1. For example, a booster pump, which may be similar to pump 5, may be included between HSD 40 and reactor 10 for boosting the pressure into reactor 10, and/or a pump may be positioned on line 24 for recycle of hydrogen-containing gas to HSD 40. As another example, a supplemental feed pump, which may be similar to pump 5, may be included for introducing additional reactants, and/or catalyst into reactor 10. In embodiments in which a catalyst slurry comprising solid catalyst is circulated throughout high shear system 100, it may be desirable to utilize pumps made of durable material, such as ceramic, to minimize erosion.

Improved Hydrocracking Process.

Operation of high shear hydrocracking system 100 will now be discussed with reference to FIG. 1D. In operation for the improved hydrocracking process, a dispersible gas stream comprising hydrogen and optionally one or more hydrocarbons from C1-C6 is introduced into system 100 via line 22, and combined in line 13 with a liquid/slurry stream comprising heavier hydrocarbons.

The liquid/slurry stream in line 21 may be a hydrocarbonaceous feedstock suitable for hydrocracking, such as, without limitation, one or more of crude petroleum, reduced crudes (coker tower bottoms fraction reduced crude), vacuum tower residua, coker gas oils, cycle oils, FCC tower bottoms, vacuum gas oils, deasphalted (vacuum) residua, coal derived oils, other heavy oils, bitumen, and tar sand. In embodiments, the liquid/slurry stream comprises vacuum gas oil, gas oil, heavy oil, reduced crude, vacuum distillation residua, or a combination thereof.

The hydrocarbonaceous feedstock may be selected from heavy naphthas, kerosenes, refractory catalytically cracked cycle stocks, high boiling virgin and coker gas oils, and combinations thereof. Oils derived from coal, shale, and/or tar sands may also be treated via the disclosed high shear hydrocracking process. This includes liquefaction of coal, where solid coal is provided in a liquid form and hydrogenated to provide a liquid at atmospheric conditions with rejection of ash and sulfur. Coal dissolution can be accomplished under high temperature (about 400° C.) and pressure (about 1500 to about 3000 psi) with hydrogen and a coal-derived solvent. At high severities, hydrocracking may convert these materials to gasoline and lower boiling paraffins; lesser severities may permit the higher boiling feedstocks to be converted into lighter distillates, such as diesel fuels and aviation kerosenes.

In the refining of crude petroleum oils, it is customary to fractionally distill the crude at atmospheric pressure to recover gasoline, naphtha, kerosene and atmospheric gas oils as overhead, and leave as still bottoms an atmospheric residuum. Distillation is then continued at reduced pressure and there is obtained overhead vacuum gas oils and light lubricating oil distillates, leaving a vacuum residuum. In embodiments, the hydrocarbonaceous feedstock comprises vacuum gas oil boiling at a temperature in the range of from about 343° C. (650° F.) to about 593° C. (1100° F.), and/or gas oils boiling in the range of from about 204° C. (400° F.) to about 343° C. (650° F.). In embodiments, feedstream in line 21 comprises vacuum gas oil boiling around 343° C. (650° F.) to about 593° C. (1100° F.) from a crude unit vacuum column or residual desulphurization unit vacuum column. In embodiments, the hydrocarbonaceous feedstream comprises oils generally boiling above 343° C. (650° F.). In embodiments, the hydrocarbonaceous feedstream comprises heavy oils containing high molecular weight, long chain paraffins and high molecular weight aromatics with a large proportion of fused ring aromatics. In embodiments, the feedstock comprises atmospheric residuum.

In embodiments, a preliminary hydrotreating or cleaning step (not shown in FIG. 1D) is incorporated to remove nitrogen and sulfur and to saturate aromatics to naphthenes without substantial boiling range conversion. This hydrotreating may improve hydrocracking catalyst performance and/or permit lower temperatures, higher space velocities, lower pressures or combinations of these conditions to be employed.

As mentioned above, hydrocarbonaceous feedstock in line 21 is pumped via line 13 into HSD 40. In some embodiments, feedstock to HSD 40 comprises fresh hydrocarbonaceous fluid and a recycle stream comprising unconverted hydrocarbons, for example, from reactor 10, separator 30, or fractionator 50, for example from line 20.

A gas stream is introduced into HSD 40 with the hydrocarbonaceous feedstock. Such gas stream may be introduced into HSD 40 by introduction into line 13 via dispersible gas line 22. In alternative embodiments, gas stream and liquid/slurry hydrocarbonaceous feedstock are introduced separately into HSD 40. In embodiments, the feedstream to HSD 40 comprises an excess of hydrogen. Use of excess hydrogen in hydrocracker 10 may provide for rapid hydrogenation of broken carbon to carbon bonds, resulting in enhanced desirable product yield and/or selectivity.

A portion of dispersible gas stream in line 22 may comprise net recycle hydrogen from stream 24, for example, which may be recycled to HSD 40 via line 24. It should be noted that FIG. 1D is a simplified process diagram and many pieces of process equipment, such as separators, heaters and compressors, have been omitted for clarity.

In embodiments, the gas stream is fed directly into HSD 40, instead of being combined with the liquid reactant stream (i.e., hydrocarbonaceous fluid) in line 13. Pump 5 may be operated to pump the liquid reactant (hydrocarbonaceous fluid comprising high molecular weight compounds to be hydrocracked) through line 21, and to build pressure and feed HSD 40, providing a controlled flow throughout HSD 40 and high shear system 100. In some embodiments, pump 5 increases the pressure of the HSD inlet stream to greater than 202.65 kPa (2 atm), or greater than about 303.975 kPa (3 atmospheres). In this way, high shear system 100 may combine high shear with pressure to enhance reactant intimate mixing.

After pumping, the gas and liquid/slurry reactants (higher molecular weight hydrocarbon compounds in line 13) are mixed within HSD 40, which serves to create a supersaturated dispersion of the gas in the hydrocarbonaceous fluid.

In improved hydrocracking system 100, dispersion in line 18 from high shear device 40 comprises a supersaturated dispersion to be hydrocracked and/or hydrogenated. For example, disperser IKA® model DR 2000/4, a high shear, three stage dispersing device configured with three rotors in combination with stators, aligned in series, may be used to create the dispersion of dispersible gas in a fluid medium comprising higher molecular weight hydrocarbons to be hydrocracked (i.e., “the reactants”). The rotor/stator sets may be configured as illustrated in FIG. 2, for example. The combined reactants enter the high shear device via line 13 and enter a first stage rotor/stator combination. The rotors and stators of the first stage may have circumferentially spaced first stage rotor teeth and stator teeth, respectively. The coarse dispersion exiting the first stage enters the second rotor/stator stage. The rotor and stator of the second stage may also comprise circumferentially spaced rotor teeth and stator teeth, respectively. The reduced bubble-size dispersion emerging from the second stage enters the third stage rotor/stator combination, which may comprise a rotor and a stator having rotor teeth and stator teeth, respectively. The dispersion exits the high shear device via line 18.

In some embodiments, the shear rate increases stepwise longitudinally along the direction of the flow, 260. For example, in some embodiments, the shear rate in the first rotor/stator stage is less than or greater than the shear rate in subsequent stage(s). In other embodiments, the shear rate is substantially constant along the direction of the flow, with the shear rate in each stage being substantially the same.

If the high shear device 40 includes a PTFE seal, the seal may be cooled using any suitable technique that is known in the art. For example, the reactant stream flowing in line 13 may be used to cool the seal and in so doing be preheated as desired prior to entering high shear device 40.

The rotor(s) of HSD 40 may be set to rotate at a speed commensurate with the diameter of the rotor and the desired tip speed. As described above, the high shear device (e.g., colloid mill or toothed rim disperser) has either a fixed clearance between the stator and rotor or has adjustable clearance. HSD 40 serves to intimately mix the hydrogen-containing gas and the reactant liquid (i.e., hydrocarbonaceous feedstock in line 13). In some embodiments of the process, the transport resistance of the reactants is reduced by operation of the high shear device such that the velocity of the reaction is increased by greater than about 5%. In some embodiments of the process, the transport resistance of the reactants is reduced by operation of the high shear device such that the velocity of the reaction is increased by greater than a factor of about 5. In some embodiments, the velocity of the reaction is increased by at least a factor of 10. In some embodiments, the velocity is increased by a factor in the range of about 10 to about 100 fold.

In some embodiments, HSD 40 delivers at least 300 L/h at a tip speed of at least 4500 ft/min, and which may exceed 7900 ft/min (40 m/s). The power consumption may be about 1.5 kW. Although measurement of instantaneous temperature and pressure at the tip of a rotating shear unit or revolving element in HSD 40 is difficult, it is estimated that the localized temperature seen by the intimately mixed reactants is in excess of 500° C. and at pressures in excess of 500 kg/cm² under cavitation conditions. In some embodiments, the high shear mixing results in a supersaturated dispersion comprising micron and/or submicron-sized gas bubbles in a continuous phase comprising hydrocarbonaceous compounds to be hydrocracked. In some embodiments, the resultant dispersion has an average bubble size of less than about 1.5 μm. Accordingly, the dispersion exiting HSD 40 via line 18 comprises micron and/or submicron-sized gas bubbles. In some embodiments, the resultant dispersion has an average bubble size of less than 1 μm. In some embodiments, the mean bubble size is in the range of about 0.4 μm to about 1.5 μm. In some embodiments, the mean bubble size is less than about 400 μm, and may be about 100 nm in some cases. In many embodiments, the microbubble dispersion is able to remain dispersed at atmospheric pressure for at least 15 minutes.

Once dispersed, the resulting dispersion exits HSD 40 via line 18 and feeds into reactor 10, as illustrated in FIG. 1D. Optionally, the dispersion may be further processed prior to entering reactor 10, if desired. In embodiments, reactor 10 is a fixed bed reactor comprising a fixed bed of catalyst. Suitable catalysts are known to those experienced in the art, and include, without limitation, zeolite-based catalyst, as well as supported catalysts (e.g., containing Co/Mo, Co/Ni) and dispersed catalyst (e.g., containing Fe, Mo.) In reactor 10, hydrocracking and/or free radical reactions occurs in the presence of hydrocracking catalyst, as the dispersion from HSD 40 contacts catalyst. The contents in reactor 10 may be stirred continuously or semi-continuously, the temperature of the reactants may be controlled (e.g., using a heat exchanger), pressure in the vessel may be monitored using suitable pressure measurement instrumentation, and the fluid level inside reactor 10 may be regulated using standard techniques. Hydrocracked product may be produced either continuously, semi-continuously or batch wise, as desired for a particular application.

In embodiments, reactor 10 comprises a fixed bed of catalyst. In embodiments, reactor 10 comprises a trickle bed reactor. Hydrocracking catalyst may be introduced continuously or non-continuously into reactor 10 via an inlet line (not shown in FIG. 1D), as a slurry or catalyst stream. Alternatively, or additionally, catalyst may be added elsewhere in system 100. For example, catalyst slurry may be injected into line 21, in some embodiments.

In embodiments, reactor 10 comprises a bed of suitable catalyst known to those of skill in the art to be suitable for hydrocracking as described hereinabove.

Reactor Conditions.

The temperature and pressure within reactor 10, which indicate process severity along with other reaction conditions, may vary depending on the feed, the type of catalyst employed, and the degree of hydroconversion sought in the process. In embodiments, a lower hydroconversion may be desirable, for example, to decrease hydrogen consumption. At low conversions, n-paraffins in a feedstock may be converted in preference to the iso-paraffins, while at higher conversions under more severe conditions iso-paraffins may also be converted.

The supersaturated dispersion contacts the catalyst under hydrocracking conditions of elevated temperature and pressure. In embodiments, conditions of temperature, pressure, space velocity and hydrogen ratio which are similar to those used in conventional hydrocracking are employed.

In embodiments, hydrocracking in reactor 10 takes place at temperatures in the range of from about 100° C. to about 400° C., and at an elevated pressure in the range of from about 101.325 kPa to about 13.2 MPa (1 atmospheres to 130 atmospheres) of absolute pressure. In embodiments, hydrocracker 10 is operated at a temperature in the range of from about 350° C. to about 450° C. (650° F. to 850° F.). In embodiments, the pressure of reactor 10 is greater than about 7,000 kPa (1,000 psig). In embodiments, the pressure of reactor 10 is in the range of from about 5171 kPa (750 psig) to about 69 MPa (10,000 psig), or from about 6.9 MPa (1,000 psig) to about 27.5 MPa (4,000 psig). In embodiments, the hydrogen partial pressure in reactor 10 is in the range of from about 600 kPa to about 20,000 kPa. High hydrogen pressures may be desirable to prevent catalyst aging, and thus maintain sufficient activity to permit the process to be operated with a fixed bed of catalyst for periods of one to two years or more without the need for regeneration. In some embodiments, the pressure in reactor 10 is in the range of from about 202.65 kPa (2 atm) to about 5.6 MPa-6.1 MPa (55-60 atm). In some embodiments, reaction pressure is in the range of from about 810.6 kPa to about 1.5 MPa (8 atm to about 15 atm).

The ratio of hydrogen to the hydrocarbon feedstock in the dispersion from HSD 40 may be in the range of from about 0.009 m³/L to about 3.6 m³/L (50 to 20,000 SCF/bbl). The ratio of gas to the hydrocarbon feedstock in the dispersion from HSD 40 may be in the range of from about 50 to about 20,000 SCF/bbl. The space velocity of the feedstock may be in the range of from about 0.1 to about 20 LHSV (liquid hourly space velocity), or in the range of from about 0.1 to about 1.0 LHSV.

Hydrocracked/hydrogenated product exits reactor 10 by way of line 16. In embodiments, product stream in line 16 comprises a two-phase mixture of liquid and gas or of slurry and gas. Hydrocracked product in line 16 comprises any unreacted hydrogen gas, (e.g., unreacted) higher molecular weight hydrocarbons, and lower boiling point hydrocarbons produced by hydrocracking of heavier hydrocarbons in the hydrocarbonaceous feedstream.

Downstream Processing.

The effluent from the hydrocracking reactor exits the hydrocracking zone via line 16. The effluent from the reactor comprises a two-phase mixture of liquid and gases. In embodiments, the principal components of the liquid phase of the effluent are C5 and higher hydrocarbons. Upon removal from the reactor, product stream in line 16 may be passed to a product upgrade system for further processing. Product upgrading may produce a wide range of commercial products, for example, without limitation, gasoline, lube oil, and/or middle distillate fuels, including, without limitation, diesel, naphtha, kerosene, jet fuel, and/or fuel oil.

The product in line 16 may be further treated as known to those of skill in the art. In embodiments, line 16 fluidly connects a reactor with a separator zone 30. Separator zone 30 may comprise, for example, a high pressure separator from which hydrogen and light gases are removed via line 24, and a separated product stream is extracted via line 36. Separator zone 30 may be fluidly connected to fractionator 50 via line 36. Fractionator 50 may be a fractional distillation column operating at lower pressure than separator 30. Converted (hydrocracked) product may be taken overhead from fractionator 50 via line 45. Heavy (e.g., unconverted) oil may be removed from the bottom of fractionator 50 via line 35. For further conversion, at least a portion of the bottoms stream from fractionator 50 comprising unconverted and/or heavy oil may be recycled via, for example, line 20, to high shear device 40 for further conversion. Line 20 may be connected with line 21, for example, for recycle to HSD 40 of unconverted hydrocarbonaceous product.

In embodiments, the product in line 35 is further treated as known to those of skill in the art. For example, the product stream 35 may be subjected to dewaxing process.

Multiple Pass Operation.

In the embodiment shown in FIG. 1D, the system is configured for single pass operation, wherein the output 16 from a reactor goes directly to further processing for recovery of hydrocracked product. In some embodiments it may be desirable to pass the contents of a reactor, or a liquid fraction containing high boiling compounds, through HSD during a subsequent pass. In this case, unconverted compounds may be introduced into HSD by injection into line 21, line 13, and/or line 18, for example. In embodiments, line 16, line 36, line 20, or a combination thereof is connected to line 21, such that at least a portion of the contents of a downstream line comprising unconverted and/or heavy hydrocarbonaceous compounds is recycled to HSD 40. Recycle may be by way of pump 5 and line 13 and thence HSD 40. Additional gas comprising hydrogen and optionally at least one hydrocarbon from C1-C6 may be injected via line 22 into line 13, or it may be added directly into the high shear device (not shown).

Multiple High Shear Devices.

In some embodiments, two or more high shear devices like HSD 40, or configured differently, are aligned in series, and are used to further enhance the reaction. Their operation may be in either batch or continuous mode. In some instances in which a single pass or “once through” process is desired, the use of multiple high shear devices in series may also be advantageous. For example, in embodiments, outlet dispersion in line 18 may be fed into a second high shear device. When multiple high shear devices are operated in series, additional dispersible gas comprising hydrogen may be injected into the inlet feedstream of each high shear device. In some embodiments, multiple high shear devices are operated in parallel, and the outlet dispersions therefrom are introduced into one or more reactors 10.

The supersaturated dispersion comprising the micrometer sized and/or submicrometer sized gas bubbles in line 18 produced within high shear device results in faster and/or more complete hydrocracking in reactor 10. As mentioned hereinabove, additional benefits may be an ability to operate a reactor at lower temperatures and/or pressures, resulting in operating and/or capital cost savings.

Additional Catalyst.

In some embodiments, additional catalyst is added as needed to the high shear device, to the reactor, or to both via any suitable means known to one skilled in the art. Such addition is also referred to herein as inter-stage injection.

Additional Feedstock.

In some embodiments, additional feedstock (gas, liquid/slurry, or a combination thereof) is added as needed to the high shear device, to the reactor, or to both via any suitable means known to one skilled in the art. In some embodiments, inter-stage injection of catalyst and inter-stage injection of feedstock are combined.

Inter-Stage Injection and Multi-HSD.

In some embodiments, inter-stage injection of additional catalyst and/or additional feedstock is combined with the use of multiple high shear devices. In such embodiments, the system components may be arranged in many different configurations, and all such variations are considered to be within the scope of this disclosure.

Improved Hydrogenation.

The improved method and system as described herein is also applicable to hydrogenation processes, such as hydro-treating, hydro-finishing, and hydro-desulfurization.

Combining Associated Gas with Hydrocarbon Liquids.

In some embodiments, a high shear device is utilized to incorporate associated gas into hydrocarbon liquid that has been extracted from a well. The high shear device enables super-saturation of the gas in the hydrocarbon. High shear also creates free radicals that can result in chemical bonding of the associated gases with liquid hydrocarbon. Free radical reactions can optionally be enhanced by catalytic means either incorporated within the surfaces of the high shear unit or by subjecting the high sheared mixture to catalyst located downstream of the high shear device. In some embodiments, desulfurization of the hydrocarbon mixture is required to prevent catalyst poisoning. Desulfurization techniques are known to those skilled in the art. In some embodiments, hydrogen or hydrogen rich gas are also introduced prior to the high shear unit in order to reduce unsaturation or to hydrotreat the hydrocarbon mixture.

In various embodiments, high shear devices are utilized in parallel or in series to optimize the level and stability of associated gas in hydrocarbon liquid. In some embodiments, high shear devices are positioned at selective locations along a pipeline to maintain or enhance super-saturation of the associated gas in hydrocarbon liquid as it is being transported.

The method as described above allows for transporting the high shear treated mixture of associated gas and hydrocarbon liquid through conventional liquid transportation means to locations such as refineries, where the hydrocarbon mixture is processed by refining techniques as known to one skilled in the art.

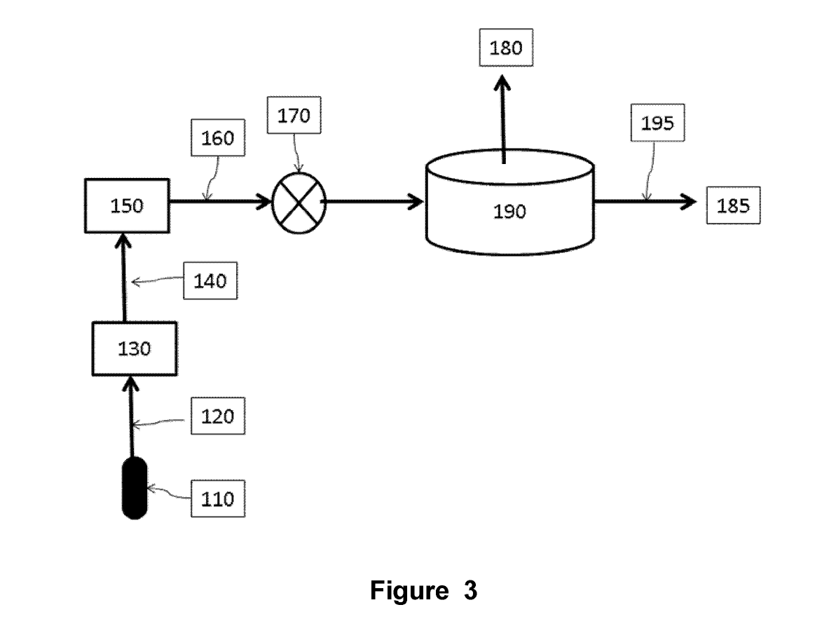

FIG. 3 illustrates a configuration of the high shear device used to incorporate associated gases into hydrocarbon liquids. A mixture of liquids and gases 120 exits the wellhead 110 and optionally enters a pre-treatment device 130. Pretreatment 130 of the hydrocarbon stream 120 may include pressure regulation, filtering and/or sulfur removal. Pressure regulation is required when the pressure of the hydrocarbon 120 stream needs to be either reduced or increased and may consist of either a pumping device or pressure throttling device. The pressure at which the hydrocarbon stream 140 should enter the high shear device 150 will depend on the pressure at which the supersaturated liquid is transported to the end processing plant (not shown), such as a refinery. The hydrocarbon stream 140 is therefore at a pressure at or below that of the supersaturated stream to avoid any pressure reduction that might result in gas separation due to a pressure reduction.

The hydrocarbon stream 140 may be a two phase system consisting of gas and liquid hydrocarbon that enters one or more high shear units 150. Multiple high shear units may be configured either in series or parallel. A supersaturated fluid 160 exits the high shear unit 150 where formation of free radicals in the high shear unit 150 may result in recombination of a portion of the hydrocarbon stream 160. Optionally a pumping device 170 may be included to maintain pressure and deliver the supersaturated hydrocarbon stream 160 to a gas separation chamber 190 where excess volatile gases 180 that have not been incorporated into the supersaturated stream 160 are removed and either recycled or otherwise used. The supersaturated hydrocarbon 195 that is void of free hydrocarbon gases may then be transported as a liquid to the desired end use application 185.

Advantages.

Without wishing to be limited by theory, some benefits of the improved hydrocracking system and method are herein discussed. The action of high shear promotes the supersaturation/incorporation of the gas components in the formed dispersion, which further promotes the formation of desired hydrocarbon compounds (such as gasoline components, jet fuel components, diesel components) in the product stream. The high shear action also produces free radicals in the dispersion to initiate free radical reactions. Depending on the feed gas stream, such free radicals include H., CH₃., CH₂., and/or CH.. Due to high shear, the mixing may take place at a lower bulk or global temperature, which increases the incorporation of gas in the liquid/slurry stream. Furthermore, the high shear action may enable long chain hydrocarbons (such as those found in tar sand and bitumen) to be treated in the cracking/hydrogenation unit, since the long chain hydrocarbons favor the incorporation of gas molecules. The high shear action, in various embodiments, also reduces coking. Additionally, the high shear mixing action coats the catalyst particles with the reactants, which may increase the catalytic reaction rate and/or the longevity of the catalyst. The benefits of the herein disclosed system and method may include, but are not limited to, faster cycle times, increased throughput, more effective use of catalyst, higher degree of hydro-conversion, reduced operating costs and/or reduced capital expense due to the possibility of designing smaller hydrocracking reactors, and/or operating the hydrocracking process at lower temperature and/or pressure.

The application of enhanced mixing of the reactants by HSD potentially permits more effective hydrocracking of hydrocarbonaceous streams. In some embodiments, the enhanced mixing potentiates an increase in throughput of the process stream. In some embodiments, the high shear mixing device is incorporated into an established process, thereby enabling an increase in production (i.e., greater throughput). In contrast to some methods that attempt to increase the degree of hydrocracking by simply increasing hydrocracker temperature, catalyst acidity, or residence time, the superior dispersion and contact provided by external high shear mixing may in many cases allow a decrease in overall operating temperature, residence time, and/or catalyst acidity, while maintaining or even increasing throughput.

Without wishing to be limited to a particular theory, it is believed that the level or degree of high shear contacting is sufficient to increase rates of mass transfer, and also produces localized non-ideal conditions that enable reactions to occur that would not otherwise be expected to occur based on Gibbs free energy predictions. Localized non ideal conditions are believed to occur within the high shear device, resulting in increased temperatures and pressures, with the most significant increase believed to be in localized pressures. The increase in pressures and temperatures within the high shear device are instantaneous and localized and quickly revert back to bulk or average system conditions once exiting the high shear device. In some cases, the high shear mixing device induces cavitation of sufficient intensity to dissociate one or more of the reactants into free radicals, which may intensify a chemical reaction or allow a reaction to take place at less stringent conditions than might otherwise be expected. Cavitation may also increase rates of transport processes by producing local turbulence and liquid micro-circulation (acoustic streaming). An overview of the application of cavitation phenomenon in chemical/physical processing applications is provided by Gogate et al., “Cavitation: A technology on the horizon,” Current Science 91 (No. 1): 35-46 (2006). The high shear mixing device of certain embodiments of the present system and methods induces cavitation, whereby hydrogen and hydrocarbonaceous compounds are dissociated into free radicals, which then react to produce lower boiling hydrocracked product compounds.

In some embodiments, the system and methods described herein permit design of a smaller and/or less capital intensive process than previously possible without the use of external high shear device 40. Potential advantages of certain embodiments of the disclosed methods are reduced operating costs and increased production from an existing process. Certain embodiments of the disclosed processes additionally offer the advantage of reduced capital costs for the design of new processes. In embodiments, dispersing hydrogen-containing gas in hydrocarbonaceous fluid comprising compounds to be hydrocracked/hydrogenated with a high shear device decreases the amount of unreacted hydrogen (for example, hydrogen removed in line 24).

The present methods and systems for hydrocracking of hydrocarbonaceous fluids via hydrocracking employ an external high shear mechanical device to provide rapid contact and mixing of chemical ingredients in a controlled environment in the reactor/high shear disperser device. The high shear device reduces the mass transfer limitations on the reaction, and thus increases the overall reaction rate, and may allow substantial hydrocracking under global operating conditions under which substantial reaction may not be expected to occur.

In embodiments, the process of the present disclosure provides for a higher selectivity to desirable hydrocarbons than conventional hydrocracking processes comprising an absence of external high shear mixing. In embodiments, the degree of mixing in external high shear device is varied to attain a desired outlet product profile. In embodiments, the high shear hydrocracking process of the present disclosure allows the operation of hydrocracker 10 at a lower temperature, whereby longer hydrocarbons are produced. In embodiments, the use of the present system and method for the hydrocracking of hydrocarbonaceous feedstock makes economically feasible the use of reduced amounts of hydrogen, by increasing the rate of cracking/hydrogenation (decreasing mass transfer resistance).

The use of high shear action may also further reduce the sulfur content of FCC products because the excess hydrogen produced by the addition of methane or other hydrogen rich gases that release hydrogen radicals, which then react with sulfur in the product. This reduces sulfur levels and reduces the sulfur load for downstream processing, e.g., hydro-finishing, hydro-desulfurization.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

What is claimed is:

1. A method for hydrogenation comprising:
supersaturating a hydrocarbonaceous liquid or slurry stream in a high shear device with a gas stream comprising hydrogen and optionally one or more C1-C6 hydrocarbons to form a supersaturated dispersion;
introducing the supersaturated dispersion into a reactor in the presence of a hydrogenation catalyst to generate a product stream.

2. The method of claim 1 wherein the catalyst is present as a slurry or a fluidized or fixed bed of catalyst.

3. The method of claim 1 wherein the hydrogenation catalyst is mixed with said hydrocarbonaceous liquid or slurry stream and said gas stream in the high shear device.

4. The method of claim 1 further comprising recycling at least a portion of an off gas from the reactor, recycling at least a portion of the product stream from the reactor, or both.

5. The method of claim 4 wherein said off gas comprises hydrogen, and optionally one or more C1-C6 hydrocarbons, and wherein said off gas is introduced into said high shear device.

6. The method of claim 1 wherein said product stream comprises an improved product distribution of hydrocarbon compounds, wherein improved product distribution refers to a higher content of C3+ hydrocarbons compared to the totality of feed streams.

7. The method of claim 1 wherein said liquid or slurry stream comprises bitumen, tar sand, asphaltene, or a combination thereof.

8. The method of claim 1 wherein said liquid or slurry stream comprises a petroleum, animal, or plant derived hydrocarbon.

9. The method of claim 1 wherein said liquid or slurry stream comprises at least one component selected from the group consisting of coker bottoms, reduced crudes, recycle oils, fluid catalytic cracking (FCC) bottoms, crude petroleum, vacuum tower residua, coker gas oils, cycle oils, vacuum gas oils, deasphalted residua, heavy oils, coal derived oils, vacuum distillation residua, heavy naphthas, kerosenes, refractory catalytically cracked cycle stocks, high boiling virgin, and combinations thereof.

10. The method of claim 1 wherein said dispersion is up to 50% supersaturated.

11. The method of claim 1 wherein said supersaturation promotes the formation of desired product distribution in the reactor product stream.

12. The method of claim 1 wherein said supersaturation under high shear promotes free radical formation and free radical reactions.

13. The method of claim 1 wherein forming the supersaturated dispersion comprises utilizing a shear rate of greater than about 20,000 s⁻¹.

14. The method of claim 1 wherein the high shear device comprises at least one rotor-stator combination, and wherein the at least one rotor is rotated at a tip speed of at least 22.9 m/s (4,500 ft/min) during formation of the dispersion.

15. The method of claim 1 wherein said hydrogenation comprises hydrocracking.

16. The method of claim 1 wherein said hydrogenation comprises hydro-treating, hydro-finishing, hydro-desulfurization, or a combination thereof.

17. A system for hydrogenation comprising:
at least one high shear device configured to provide high shear action comprising:
an inlet for a hydrocarbonaceous fluid stream,
an optional inlet for a gas stream comprising hydrogen and optionally one or more C1-C6 hydrocarbons,
an outlet for a supersaturated dispersion formed under the high shear action, and
at least one generator comprising a rotor and a stator separated by a shear gap, wherein the shear gap is the minimum distance between the rotor and the stator; wherein the high shear mixing device is capable of producing a tip speed of the rotor of greater than 5.0 m/s (about 1,000 ft/min); and
a reactor comprising an inlet fluidly connected to the outlet of the high shear device and an outlet for a product stream comprising an improved product distribution of hydrocarbon compounds.

18. The system of claim 17 further comprising a separator downstream of the reactor.

19. The system of claim 17 further comprising a fractionator downstream of the reactor.

20. The system of claim 17 wherein the at least one high shear device is capable of producing a tip speed of at least 22.9 m/s.

21. The system of claim 17 wherein the at least one high shear device is capable of producing a tip speed of at least 40.1 m/s.

22. The system of claim 17 wherein the at least one high shear device comprises at least two generators.

23. The system of claim 17 wherein the high shear device is configured to produce a shear rate of greater than 20,000 s⁻¹, wherein the shear rate is the tip speed of the rotor divided by the shear gap.

24. A method comprising:
mixing an associated gas with a hydrocarbon liquid in a high shear device to produce a supersaturated dispersion; and
transporting said supersaturated dispersion.

25. The method of claim 24 wherein said high shear device is positioned in proximity to an oil production well.

26. The method of claim 24 wherein said supersaturated dispersion is produced via free radical reactions.

27. The method of claim 24 wherein said supersaturated dispersion is produced under the action of a catalyst.

28. The method of claim 24 further comprising desulfurizing said hydrocarbon liquid.

29. The method of claim 24 further comprising hydrotreating said hydrocarbon liquid.

30. The method of claim 24 wherein said supersaturated dispersion is transported in an existing pipeline.

31. The method of claim 30 comprising utilizing more than one high shear device along the pipeline to maintain or enhance supersaturation of the gas in the liquid.
